(19) United States
(12) Patent Application Publication
(10) Pub. No.: US 2007/0113207 A1
(43) Pub. Date: May 17, 2007

(54) Methods and systems for gesture classification in 3D pointing devices

(75) Inventor: Charles W. K. Gritton, Sterling, VA (US)

Correspondence Address: POTOMAC PATENT GROUP, PLLC, P. O. BOX 270, FREDERICKSBURG, VA, 22404, US

(73) Assignee: Hillcrest Laboratories, Inc., Rockville, MD (US)

(21) Appl. No.: 11/600,950

(22) Filed: Nov. 16, 2006

Related U.S. Application Data
(60) Provisional application No. 60/737,458, filed on Nov. 16, 2005.

(51) Int. Cl. G06F 3/00

(52) U.S. Cl. 715/863; 715/864

(57) ABSTRACT

Systems and methods according to the present invention provide the ability for a system to realize when a handheld device is performing a gesture and to execute the associated command.

### RELATED APPLICATIONS

This application is related to U.S. patent application Ser. No. 11/119,663, filed on May 2, 2005 entitled “Freespace Pointing Device”, the disclosure of which is incorporated here by reference (hereafter the “'663 application”). This application is entitled “A Control Framework with a Zoomable Graphical User Interface for Organizing, Selecting and Launching Media Items”, the disclosure of which is incorporated here by reference (hereafter the “'432 application”). Additionally this application is related to, and claims priority from, U.S. Provisional Patent Application Ser. No. 60/737,458, filed on Nov. 16, 2005, entitled “Methods and Systems for Gesture Classification in Free-Space Pointing Devices”, the disclosure of which is incorporated here by reference.

### BACKGROUND

The present invention describes methods and systems for gesture classification in handheld devices wherein inputs can be provided based on patterns of movement over time (gestures).

Technologies associated with the communication of information have evolved rapidly over the last several decades. Television, cellular telephony, the Internet and optical communication techniques (to name just a few things) combine to inundate consumers with available information and entertainment options. Taking television as an example, the last three decades have seen the introduction of cable television service, satellite television service, pay-per-view movies and video-on-demand. Whereas television viewers of the 1960s could typically receive perhaps four or five over-the-air TV channels on their television sets, today's TV watchers have the opportunity to select from hundreds, thousands, and potentially millions of channels of shows and information. Video-on-demand technology, currently used primarily in hotels and the like, provides the potential for in-home entertainment selection from among thousands of movie titles.

The technological ability to provide so much information and content to end users provides both opportunities and challenges to system designers and service providers. One challenge is that while end users typically prefer having more choices rather than fewer, this preference is counterweighted by their desire that the selection process be both fast and simple. Unfortunately, the development of the systems and interfaces by which end users access media items has resulted in selection processes which are neither fast nor simple. Consider again the example of television programs. When television was in its infancy, determining which program to watch was a relatively simple process primarily due to the small number of choices. One would consult a printed guide which was formatted, for example, as series of columns and rows which showed the correspondence between (1) nearby television channels, (2) programs being transmitted on those channels and (3) date and time. The television was tuned to the desired channel by adjusting a tuner knob and the viewer watched the selected program. Later, remote control devices were introduced that permitted viewers to tune the television from a distance. This addition to the user-television interface created the phenomenon known as “channel surfing” whereby a viewer could rapidly view short segments being broadcast on a number of channels to quickly learn what programs were available at any given time.

Despite the fact that the number of channels and amount of viewable content has dramatically increased, the generally available user interface, control device options and frameworks for televisions has not changed much over the last 30 years. Printed guides are still the most prevalent mechanism for conveying programming information. The multiple button remote control with up and down arrows is still the most prevalent channel/content selection mechanism. The reaction of those who design and implement the TV user interface to the increase in available media content has been a straightforward extension of the existing selection procedures and interface objects. Thus, the number of rows in the printed guides has been increased to accommodate more channels. The number of buttons on the remote control devices has been increased to support additional functionality and content handling, e.g., as shown in FIG. 1. However, this approach has significantly increased both the time required for a viewer to review the available information and the complexity of actions required to implement a selection. Arguably, the cumbersome nature of the existing interface has hampered commercial implementation of some services, e.g., video-on-demand, since consumers are resistant to new services that will add complexity to an interface that they view as already too slow and complex.

In addition to increases in bandwidth and content, the user interface bottleneck problem is being exacerbated by the aggregation of technologies. Consumers are reacting positively to having the option of buying integrated systems rather than a number of segregable components. An example of this trend is the combination television/VCR/DVD in which three previously independent components are frequently sold today as an integrated unit. This trend is likely to continue, potentially with an end result that most if not all of the communication devices currently found in the household will be packaged together as an integrated unit, e.g., a television/VCR/DVD/intemet access/radio/stereo unit. Even those who continue to buy separate components will likely desire seamless control of, and interworking between, the separate components. With this increased aggregation comes the potential for more complexity in the user interface. For example, when so-called “universal” remote units were introduced, e.g., to combine the functionality of TV remote units and VCR remote units, the number of buttons on these universal remote units was typically more than the number of buttons on either the TV remote unit or VCR remote unit individually. This added number of buttons and functionality makes it very difficult to control anything but the simplest aspects of a TV or VCR without hunting for exactly the right button on the remote. Many times, these universal remotes do not provide enough buttons to access many levels of control or features unique to certain TVs. In these cases, the original device remote unit is still needed, and the original hassle of handling multiple remotes remains due to user interface issues arising from the complexity of aggregation. Some remote units have addressed this problem by adding “soft” buttons that can be programmed with the expert commands. These soft buttons sometimes have accompanying LCD displays to indicate their action. These too have the flaw that they are difficult to use without looking away from the TV to the remote control. Yet another flaw in these remote units is the use of modes in an attempt to reduce the number of buttons. In these “moded” universal remote units, a special button exists to select whether the remote should communicate with the TV, DVD player, cable set-top box, VCR, etc. This causes many usability issues including sending commands to the wrong device, forcing the user to look at the remote to make sure that it is in the right mode, and it does not provide any simplification to the integration of multiple devices. The most advanced of these universal remote units provide some integration by allowing the user to program sequences of commands to multiple devices into the remote. This is such a difficult task that many users hire professional installers to program their universal remote units.

Some attempts have also been made to modernize the screen interface between end users and media systems. However, these attempts typically suffer from, among other drawbacks, an inability to easily scale between large collections of media items and small collections of media items. For example, interfaces which rely on lists of items may work well for small collections of media items, but are tedious to browse for large collections of media items. Interfaces which rely on hierarchical navigation (e.g., tree structures) may be speedier to traverse than list interfaces for large collections of media items, but are not readily adaptable to small collections of media items. Additionally, users tend to lose interest in selection processes wherein the user has to move through three or more layers in a tree structure. For all of these cases, current remote units make this selection processor even more tedious by forcing the user to repeatedly depress the up and down buttons to navigate the list or hierarchies. When selection skipping controls are available such as page up and page down, the user usually has to look at the remote to find these special buttons or be trained to know that they even exist. Accordingly, organizing frameworks, techniques and systems which simplify the control and screen interface between users and media systems as well as accelerate the selection process, while at the same time permitting service providers to take advantage of the increases in available bandwidth to end user equipment by facilitating the supply of a large number of media items and new services to the user have been proposed in the above-incorporated by reference '432 patent application.

Of particular interest for this specification are the remote devices usable to interact with such frameworks, as well as other applications and systems. As mentioned in the above-incorporated application, various different types of remote devices can be used with such frameworks including, for example, trackballs, “mouse”-type pointing devices, light pens, etc. However, another category of remote devices which can be used with such frameworks (and other applications) is 3D pointing devices. The phrase “3D pointing” is used in this specification to refer to the ability of an input device to move in three (or more) dimensions in the air in front of, e.g., a display screen, and the corresponding ability of the user interface to translate those motions directly into user interface commands, e.g., movement of a cursor on the display screen. The transfer of data between the 3D pointing device may be performed wirelessly or via a wire connecting the 3D pointing device to another device. Thus “3D pointing” differs from, e.g., conventional computer mouse pointing techniques which use a surface, e.g., a desk surface or mousepad, as a proxy surface from which relative movement of the mouse is translated into cursor movement on the computer display screen. An example of a 3D pointing device can be found in the above-incorporated by reference '663 patent application.

3D pointing devices can provide input to systems and interfaces in a variety of manners. For example, data associated with movement of the 3D pointing device can be communicated to the systems and interfaces and used to move a cursor on a display. Additionally, the 3D pointing device may have buttons, scroll wheels or other input elements which can be used to provide various other inputs. Yet another form of input which a 3D pointing device can provide is gestures. Gestures can be defined as patterns of movement of a 3D pointer over time, which are translated into predetermined commands or inputs. Some exemplary gestures are illustrated in U.S. Published Patent Application WO 2004/099903 entitled “Multimedia User Interface” filed on May 1, 2003, the disclosure of which is incorporated here by reference (hereafter the “'903 application”). In the '903 application a graphical user interface is adapted for use with a hand-held angle-sensing remote control for controlling a multi-media center. Cursor movement can be performed based on movement of the remote control while a trigger button is depressed (referred to in the '903 application as a “trigger-drag”). Another of the described controlling methods is through the use of gestures. Gestures are defined in the '903 application as changes in both left-and-right motions and up-and-down motions. These gestures are identified by defined movements of the controller while the trigger button is held.

However, processing 3D pointer movement to determine when a user intends to communicate a gesture to the system or interface, as compared to when a user does not intend to communicate a gesture is complex and may result in confusion on the part of the user, excessive use of processing resources within the system or handheld device or both. Accordingly, it would be desirable to provide methods, devices and systems which address this issue.

### SUMMARY

Systems and methods according to the present invention address these needs and others by providing a process for gesture recognition with a handheld device.

According to one exemplary embodiment of the present invention, a handheld device comprising: at least one sensor for outputting data associated with motion of the handheld device; a processing unit for evaluating the data to determine whether a predetermined gesture has been performed by the handheld device, wherein the processing unit performs the evaluation in response to a receipt of a gesture indication input.

According to another exemplary embodiment of the present invention, a method for processing gestures originating from a handheld device comprising: outputting data associated with motion of the handheld device; evaluating by a processing unit the data to determine whether a predetermined gesture has been performed by the handheld device, wherein upon receipt of a gesture indication input, the processing unit performs the evaluating.

According to another exemplary embodiment of the present invention, a means for processing gestures originating from a handheld device comprising: means for outputting data associated with motion of the handheld device; means for evaluating by a processing unit the data to determine whether a predetermined gesture has been performed by the handheld device, wherein upon receipt of a gesture indication input, the processing unit performs the evaluating.

According to yet another exemplary embodiment, a computer-readable medium containing instructions which, when executed on a computer, perform the steps of: outputting data associated with motion of the handheld device; evaluating by a processing unit the data to determine whether a predetermined gesture has been performed by the handheld device, wherein upon receipt of a gesture indication input, the processing unit performs the evaluating.

### BRIEF DESCRIPTION OF THE DRAWINGS

The accompanying drawings illustrate exemplary embodiments of the present invention, wherein:

FIG. 1 depicts a conventional remote control unit for an entertainment system;

FIG. 2 depicts an exemplary media system in which exemplary embodiments of the present invention can be implemented;

FIG. 3 shows a 3D pointing device according to an exemplary embodiment of the present invention;

FIG. 4 illustrates a cutaway view of the 3D pointing device in FIG. 4 including two rotational sensors and one accelerometer;

FIG. 5 is a block diagram illustrating processing of data associated with 3D pointing devices according to an exemplary embodiment of the present invention;

FIGS. 6(a)-6(d) illustrate the effects of tilt;

FIG. 7 depicts a hardware architecture of a 3D pointing device according to an exemplary embodiment of the present invention;

FIG. 8 is a state diagram depicting a stationary detection mechanism according to an exemplary embodiment of the present invention; and

FIG. 9 is a flowchart illustrating a method for gesture input indication according to an exemplary embodiment of the present invention.

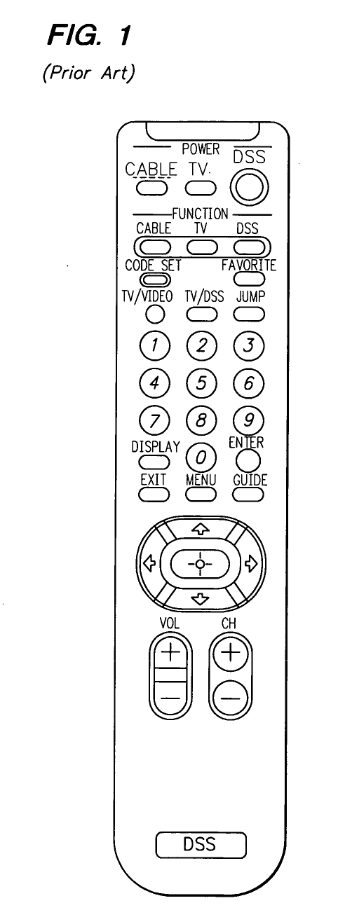

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

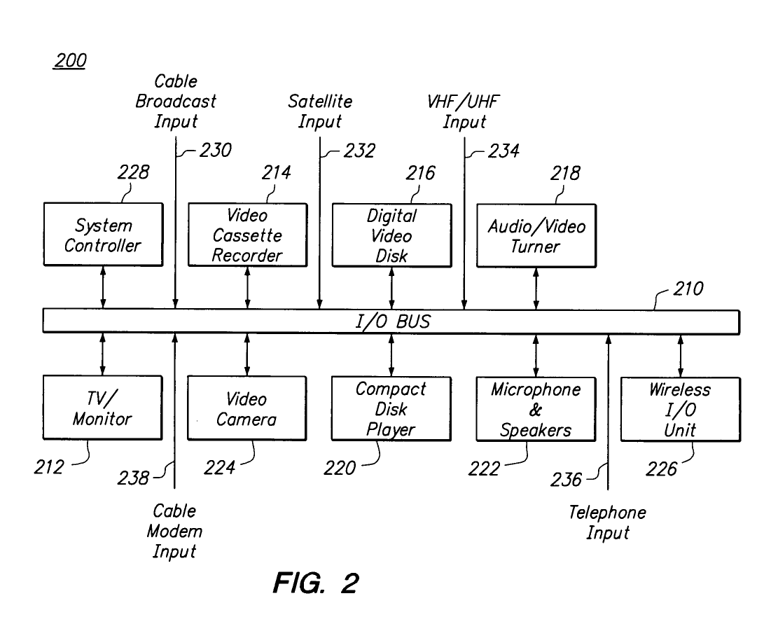

In order to provide some context for this discussion, an exemplary aggregated media system 200 in which the present invention can be implemented will first be described with respect to FIG. 2. Those skilled in the art will appreciate, however, that the present invention is not restricted to implementation in this type of media system and that more or fewer components can be included therein. Therein, an input/output (I/O) bus 210 connects the system components in the media system 200 together. The I/O bus 210 represents any of a number of different of mechanisms and techniques for routing signals between the media system components. For example, the I/O bus 210 may include an appropriate number of independent audio “patch” cables that route audio signals, coaxial cables that route video signals, two-wire serial lines or infrared or radio frequency transceivers that route control signals, optical fiber or any other routing mechanisms that route other types of signals.

In this exemplary embodiment, the media system 200 includes a television/monitor 212, a video cassette recorder (VCR) 214, digital video disk (DVD) recorder/playback device 216, audio/video tuner 218 and compact disk player 220 coupled to the I/O bus 210. The VCR 214, DVD 216 and compact disk player 220 may be single disk or single cassette devices, or alternatively may be multiple disk or multiple cassette devices. They may be independent units or integrated together. In addition, the media system 200 includes a microphone/speaker system 222, video camera 224 and a wireless I/O control device 226. According to exemplary embodiments of the present invention, the wireless I/O control device 226 is a 3D pointing device according to one of the exemplary embodiments described below. The wireless I/O control device 226 can communicate with the entertainment system 200 using, e.g., an IR or RF transmitter or transceiver. Alternatively, the I/O control device can be connected to the entertainment system 200 via a wire.

The entertainment system 200 also includes a system controller 228. According to one exemplary embodiment of the present invention, the system controller 228 operates to store and display entertainment system data available from a plurality of entertainment system data sources and to control a wide variety of features associated with each of the system components. As shown in FIG. 2, system controller 228 is coupled, either directly or indirectly, to each of the system components, as necessary, through I/O bus 210. In one exemplary embodiment, in addition to or in place of I/O bus 210, system controller 228 is configured with a wireless communication transmitter (or transceiver), which is capable of communicating with the system components via IR signals or RF signals. Regardless of the control medium, the system controller 228 is configured to control the media components of the media system 200 via a graphical user interface described below.

As further illustrated in FIG. 2, media system 200 may be configured to receive media items from various media sources and service providers. In this exemplary embodiment, media system 200 receives media input from and, optionally, sends information to, any or all of the following sources: cable broadcast 230, satellite broadcast 232 (e.g., via a satellite dish), very high frequency (VHF) or ultra high frequency (UHF) radio frequency communication of the broadcast television networks 234 (e.g., via an aerial antenna), telephone network 236 and cable modem 238 (or another source of Internet content). Those skilled in the art will appreciate that the media components and media sources illustrated and described with respect to FIG. 2 are purely exemplary and that media system 200 may include more or fewer of both. For example, other types of inputs to the system include AM/FM radio and satellite radio.

More details regarding this exemplary entertainment system and frameworks associated therewith can be found in the above-incorporated by reference U.S. patent application “A Control Framework with a Zoomable Graphical User Interface for Organizing, Selecting and Launching Media Items”. Alternatively, remote devices in accordance with the present invention can be used in conjunction with other systems, for example computer systems including, e.g., a display, a processor and a memory system or with various other systems and applications.

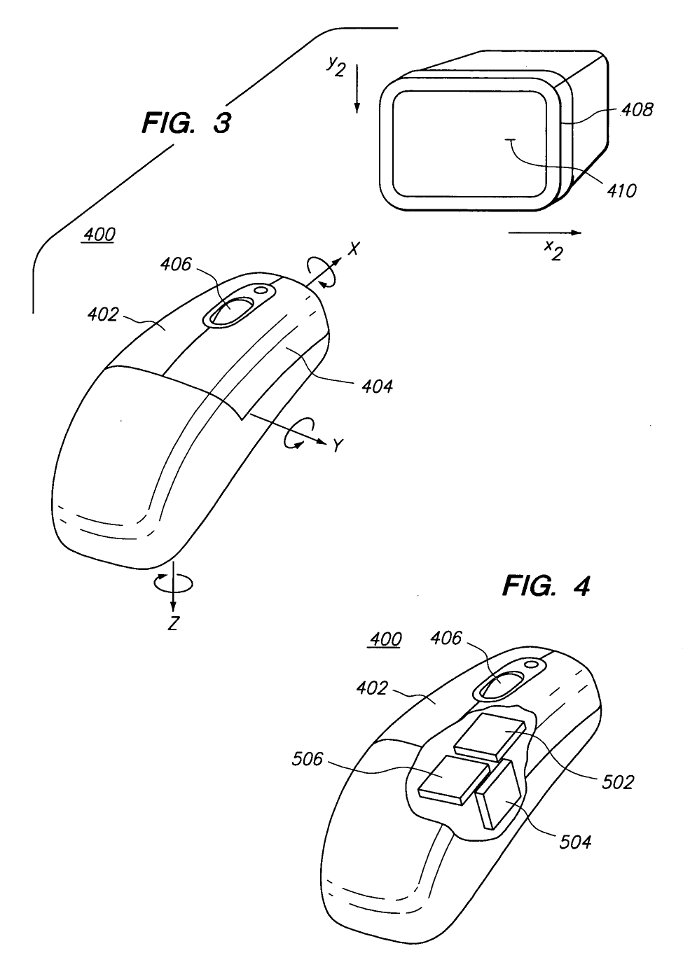

As mentioned in the Background section, remote devices which operate as 3D pointers are of particular interest for the present specification. Such devices enable the translation of movement, e.g., gestures, into commands to a user interface. An exemplary 3D pointing device 400 is depicted in FIG. 3. Therein, user movement of the 3D pointing can be defined, for example, in terms of a combination of x-axis attitude (roll), y-axis elevation (pitch) and/or z-axis heading (yaw) motion of the 3D pointing device 400. In addition, some exemplary embodiments of the present invention can also measure linear movement of the 3D pointing device 400 along the x, y, and z axes to generate cursor movement or other user interface commands. In the exemplary embodiment of FIG. 3, the 3D pointing device 400 includes two buttons 402 and 404 as well as a scroll wheel 406, although other exemplary embodiments will include other physical configurations. According to exemplary embodiments of the present invention, it is anticipated that 3D pointing devices 400 will be held by a user in front of a display 408 and that motion of the 3D pointing device 400 will be translated by the 3D pointing device into output which is usable to interact with the information displayed on display 408, e.g., to move the cursor 410 on the display 408. For example, rotation of the 3D pointing device 400 about the y-axis can be sensed by the 3D pointing device 400 and translated into an output usable by the system to move cursor 410 along the y₂ axis of the display 408. Likewise, rotation of the 3D pointing device 408 about the z-axis can be sensed by the 3D pointing device 400 and translated into an output usable by the system to move cursor 410 along the x₂ axis of the display 408. It will be appreciated that the output of 3D pointing device 400 can be used to interact with the display 408 in a number of ways other than (or in addition to) cursor movement, for example it can control cursor fading, volume or media transport (play, pause, fast-forward and rewind). Input commands may include operations in addition to cursor movement, for example, a zoom in or zoom out on a particular region of a display. A cursor may or may not be visible. Similarly, rotation of the 3D pointing device 400 sensed about the x-axis of 3D pointing device 400 can be used in addition to, or as an alternative to, y-axis and/or z-axis rotation to provide input to a user interface.

According to one exemplary embodiment of the present invention, two rotational sensors 502 and 504 and one accelerometer 506 can be employed as sensors in 3D pointing device 400 as shown in FIG. 4. The rotational sensors 502 and 504 can, for example, be implemented using ADXRS150 sensors made by Analog Devices. It will be appreciated by those skilled in the art that other types of rotational sensors can be employed as rotational sensors 502 and 504 and that the ADXRS 150 is purely used as an illustrative example. Unlike traditional gyroscopes, the ADXRS 150 rotational sensors use MEMS technology to provide a resonating mass which is attached to a frame so that it can resonate only along one direction. The resonating mass is displaced when the body to which the sensor is affixed is rotated around the sensor's sensing axis. This displacement can be measured using the Coriolis acceleration effect to determine an angular velocity associated with rotation along the sensing axis. If the rotational sensors 502 and 504 have a single sensing axis (as for example the ADXRSI50s), then they can be mounted in the 3D pointing device 400 such that their sensing axes are aligned with the rotations to be measured. For this exemplary embodiment of the present invention, this means that rotational sensor 502 is mounted such that its sensing axis is parallel to the y-axis and that rotational sensor 504 is mounted such that its sensing axis is parallel to the z-axis as shown in FIG. 4. Note, however, that aligning the sensing axes of the rotational sensors 502 and 504 parallel to the desired measurement axes is not required since exemplary embodiments of the present invention also provide techniques for compensating for offset between axes.

One challenge faced in implementing exemplary 3D pointing devices 400 in accordance with the present invention is to employ components, e.g., rotational sensors 500 and 502, which are not too costly, while at the same time providing a high degree of correlation between movement of the 3D pointing device 400, a user's expectation regarding how the user interface will react to that particular movement of the 3D pointing device and actual user interface performance in response to that movement. For example, if the 3D pointing device 400 is not moving, the user will likely expect that the cursor ought not to be drifting across the screen. Likewise, if the user rotates the 3D pointing device 400 purely around the y-axis, she or he would likely not expect to see the resulting cursor movement on display 408 contain any significant x₂ axis component. To achieve these, and other, aspects of exemplary embodiments of the present invention, various measurements and calculations are performed by the handheld device 400 which are used to adjust the outputs of one or more of the sensors 502, 504 and 506 and/or as part of the input used by a processor to determine an appropriate output for the user interface based on the outputs of the sensors 502, 504 and 506. These measurements and calculations are used to compensate for factors which fall broadly into two categories: (1) factors which are intrinsic to the 3D pointing device 400, e.g., errors associated with the particular sensors 502, 504 and 506 used in the device 400 or the way in which the sensors are mounted in the device 400 and (2) factors which are not intrinsic to the 3D pointing device 400, but are instead associated with the manner in which a user is using the 3D pointing device 400, e.g., linear acceleration, tilt and tremor. Exemplary techniques for handling each of these effects are described below.

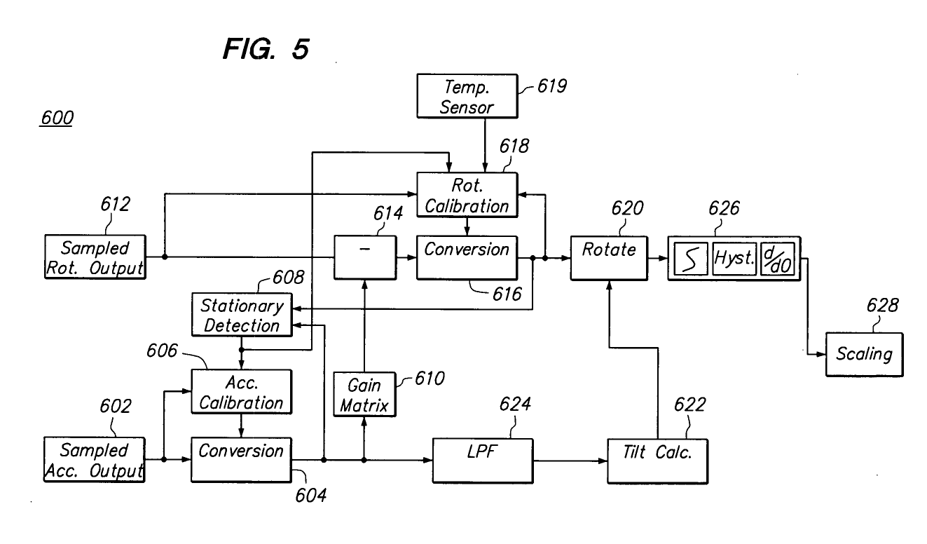

A process model 600 which describes the general operation of 3D pointing devices according to exemplary embodiments of the present invention is illustrated in FIG. 5. The rotational sensors 502 and 504, as well as the accelerometer 506, produce analog signals which are sampled periodically, e.g., 200 samples/second. For the purposes of this discussion, a set of these inputs shall be referred to using the notation (x, y, z, αy, αz), wherein x, y, z are the sampled output values of the exemplary three-axis accelerometer 506 which are associated with acceleration of the 3D pointing device in the x-axis, y-axis and z-axis directions, respectively, ay is a the sampled output value from rotational sensor 502 associated with the rotation of the 3D pointing device about the y-axis and αz is the sampled output value from rotational sensor 504 associated with rotation of the 3D pointing device 400 about the z-axis.

The output from the accelerometer 506 is provided and, if the accelerometer 506 provides analog output, then the output is sampled and digitized by an A/D converter (not shown) to generate sampled accelerometer output 602. The sampled output values are converted from raw units to units of acceleration, e.g., gravities (g), as indicated by conversion function 604. The acceleration calibration block 606 provides the values used for the conversion function 604. This calibration of the accelerometer output 602 can include, for example, compensation for one or more of scale, offset and axis misalignment error associated with the accelerometer 506. Exemplary conversions for the accelerometer data can be performed using the following equation:
A=S*((M−P).*G(T)) (1)
wherein M is a 3×1 column vector composed of the sampled output values (x, y, z), P is a 3×1 column vector of sensor offsets, and S is a 3×3 matrix that contains both scale, axis misalignment, and sensor rotation compensation. G(T) is a gain factor that is a function of temperature. The “*” operator represents matrix multiplication and the “.*” operator represents element multiplication. The exemplary accelerometer 506 has an exemplary full range of +/−2 g. Sensor offset, P, refers to the sensor output, M, for an accelerometer measurement of 0 g. Scale refers to the conversion factor between the sampled unit value and g. The actual scale of any given accelerometer sensor may deviate from these nominal scale values due to, e.g., manufacturing variances. Accordingly the scale factor in the equations above will be proportional to this deviation.

Accelerometer 506 scale and offset deviations can be measured by, for example, applying 1 g of force along one an axis and measuring the result, R1. Then a −1 g force is applied resulting in measurement R2. The individual axis scale, s, and the individual axis offset, p, can be computed as follows:
s=(R1−R2)/2 (2)
p=(R1+R2)/2 (3)
In this simple case, P is the column vector of the p for each axis, and S is the diagonal matrix of the 1/s for each axis.

However, in addition to scale and offset, readings generated by accelerometer 506 may also suffer from cross-axes effects. Cross-axes effects include non-aligned axes, e.g., wherein one or more of the sensing axes of the accelerometer 506 as it is mounted in the 3D pointing device 400 are not aligned with the corresponding axis in the inertial frame of reference, or mechanical errors associated with the machining of the accelerometer 506 itself, e.g., wherein even though the axes are properly aligned, a purely y-axis acceleration force may result in a sensor reading along the z-axis of the accelerometer 506. Both of these effects can also be measured and added to the calibration performed by function 606.

The accelerometer 506 serves several purposes in exemplary 3D pointing devices according to exemplary embodiments of the present invention. For example, if rotational sensors 502 and 504 are implemented using the exemplary Coriolis effect rotational sensors described above, then the output of the rotational sensors 502 and 504 will vary based on the linear acceleration experienced by each rotational sensor. Thus, one exemplary use of the accelerometer 506 is to compensate for fluctuations in the readings generated by the rotational sensors 502 and 504 which are caused by variances in linear acceleration. This can be accomplished by multiplying the converted accelerometer readings by a gain matrix 610 and subtracting (or adding) the results from (or to) the corresponding sampled rotational sensor data 612. For example, the sampled rotational data αy from rotational sensor 502 can be compensated for linear acceleration at block 614 as:
αy′=αy−C*A (4)
wherein C is the 1×3 row vector of rotational sensor susceptibility to linear acceleration along each axis given in units/g and A is the calibrated linear acceleration. Similarly, linear acceleration compensation for the sampled rotational data αz from rotational sensor 504 can be provided at block 614. The gain matrices, C, vary between rotational sensors due to manufacturing differences. C may be computed using the average value for many rotational sensors, or it may be custom computed for each rotational sensor.

Like the accelerometer data, the sampled rotational data 612 is then converted from a sampled unit value into a value associated with a rate of angular rotation, e.g., radians/s, at function 616. This conversion step can also include calibration provided by function 618 to compensate the sampled rotational data for, e.g., scale and offset. Conversion/calibration for both αy and αz can be accomplished using, for example, the following equation:
αrad/s=(α′−offset(T))* scale+dOffset (5)
wherein α′ refers to the value being converted/calibrated, offset(T) refers to an offset value associated with temperature, scale refers to the conversion factor between the sampled unit value and rad/s, and dOffset refers to a dynamic offset value. Equation (5) may be implemented as a matrix equation in which case all variables are vectors except for scale. In matrix equation form, scale corrects for axis misalignment and rotational offset factors. Each of these variables is discussed in more detail below.

The offset values offset(T) and dOffset can be determined in a number of different ways. When the 3D pointing device 400 is not being rotated in, for example, the y-axis direction, the sensor 502 should output its offset value. However, the offset can be highly affected by temperature, so this offset value will likely vary. Offset temperature calibration may be performed at the factory, in which case the value(s) for offset(T) can be preprogrammed into the handheld device 400 or, alternatively, offset temperature calibration may also be learned dynamically during the lifetime of the device. To accomplish dynamic offset compensation, an input from a temperature sensor 619 is used in rotation calibration function 618 to compute the current value for offset(T). The offset(T) parameter removes the majority of offset bias from the sensor readings. However, negating nearly all cursor drift at zero movement can be useful for producing a high-performance pointing device. Therefore, the additional factor dOffset, can be computed dynamically while the 3D pointing device 400 is in use. The stationary detection function 608 determines when the handheld is most likely stationary and when the offset should be recomputed. Exemplary techniques for implementing stationary detection function 608, as well as other uses therefore, are described below.

An exemplary implementation of dOffset computation employs calibrated sensor outputs which are low-pass filtered. The stationary output detection function 608 provides an indication to rotation calibration function 618 to trigger computation of, for example, the mean of the low-pass filter output. The stationary output detection function 608 can also control when the newly computed mean is factored into the existing value for dOffset. Those skilled in the art will recognize that a multitude of different techniques can be used for computing the new value for dOffset from the existing value of dOffset and the new mean including, but not limited to, simple averaging, low-pass filtering and Kalman filtering. Additionally, those skilled in the art will recognize that numerous variations for offset compensation of the rotational sensors 502 and 504 can be employed. For example, the offset(T) function can have a constant value (e.g., invariant with temperature), more than two offset compensation values can be used and/or only a single offset value can be. computed/used for offset compensation.

After conversion/calibration at block 616, the inputs from the rotational sensors 502 and 504 can be further processed to rotate those inputs into an inertial frame of reference, i.e., to compensate for tilt associated with the manner in which the user is holding the 3D pointing device 400, at function 620. Tilt correction is another significant aspect of some exemplary embodiments of the present invention as it is intended to compensate for differences in usage patterns of 3D pointing devices according to the present invention. More specifically, tilt correction according to exemplary embodiments of the present invention is intended to compensate.for the fact that users will hold pointing devices in their hands at different x-axis rotational positions, but that the sensing axes of the rotational sensors 502 and 504 in the 3D pointing devices 400 are fixed. It is desirable that cursor translation across display 408 is substantially insensitive to the way in which the user grips the 3D pointing device 400, e.g., rotating the 3D pointing device 400 back and forth in a manner generally corresponding to the horizontal dimension (x₂-axis) of the display 508 should result in cursor translation along the x₂-axis, while rotating the 3D pointing device up and down in a manner generally corresponding to the vertical dimension (Y₂-axis) of the display 508 should result in cursor translation along the y₂-axis, regardless of the orientation in which the user is holding the 3D pointing device 400.

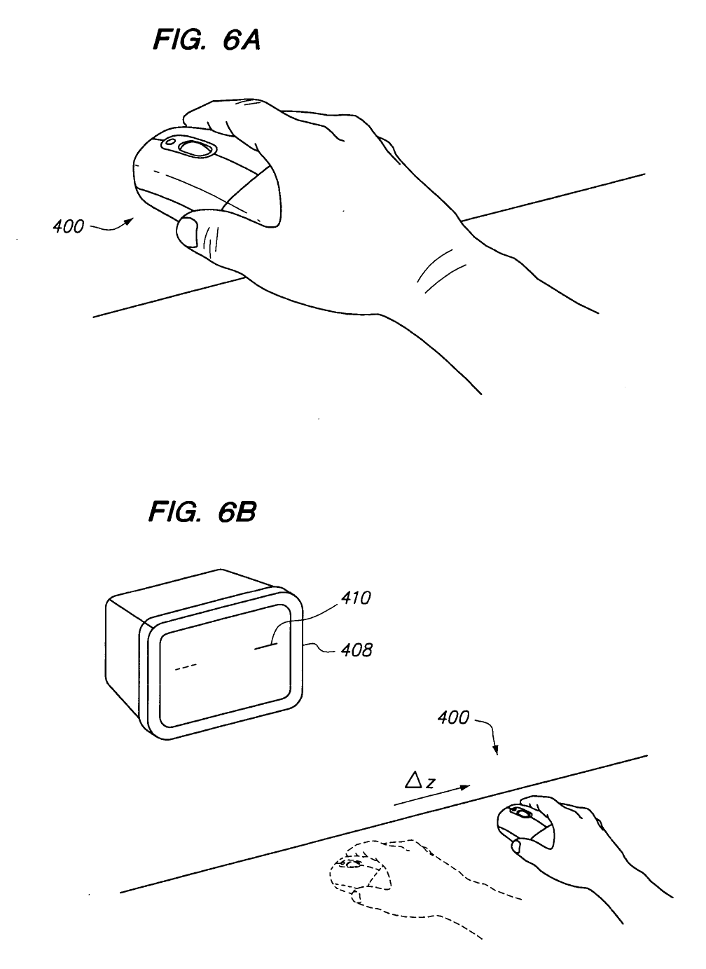

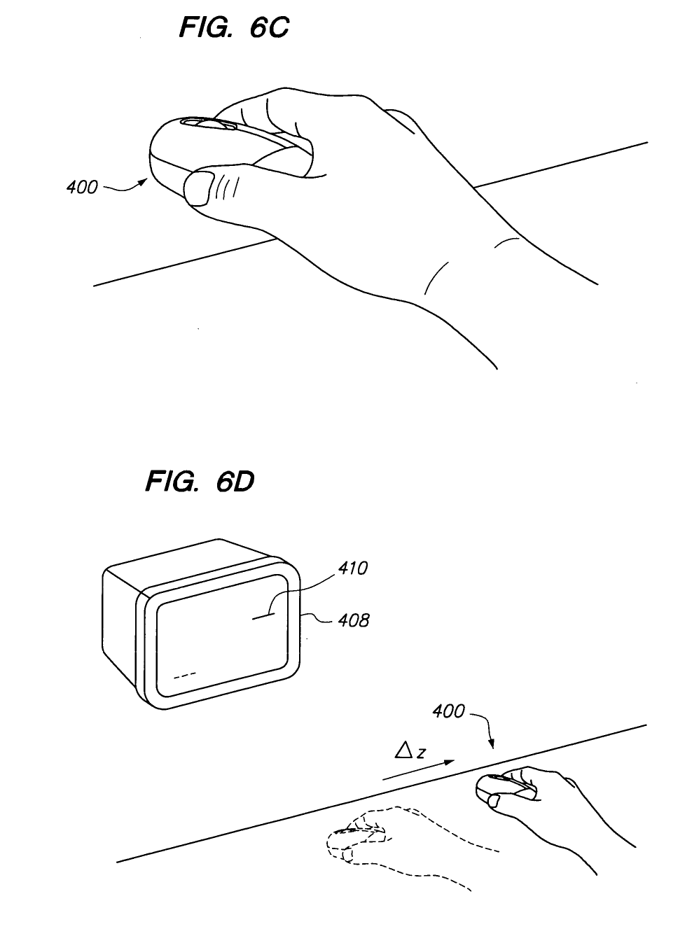

To better understand the need for tilt compensation according to exemplary embodiments of the present invention, consider the example shown in FIG. 6(a). Therein, the user is holding 3D pointing device 400 in an exemplary inertial frame of reference, which can be defined as having an x-axis rotational value of 0 degrees. The inertial frame of reference can, purely as an example, correspond to the orientation illustrated in FIG. 6(a) or it can be defined as any other orientation. Rotation of the 3D pointing device 400 in either the y-axis or z-axis directions will be sensed by rotational sensors 502 and 504, respectively. For example, rotation of the 3D pointing device 400 around the z-axis by an amount Δz as shown in FIG. 6(b) will result in a corresponding cursor translation Δx₂ in the x₂ axis dimension across the display 408 (i.e., the distance between the dotted version of cursor 410 and the undotted version).

If, on the other hand, the user holds the 3D pointing device 400 in a different orientation, e.g., with some amount of x-axis rotation relative to the inertial frame of reference, then the information provided by the sensors 502 and 504 would not (absent tilt compensation) provide an accurate representation of the user's intended interface actions. For example, referring to FIG. 6(c), consider a situation wherein the user holds the 3D pointing device 400 with an x-axis rotation of 45 degrees relative to the exemplary inertial frame of reference as illustrated in FIG. 6(a). Assuming the same z-axis rotation Δz by a user, the cursor 410 will instead be translated in both the x₂-axis direction and the y₂-axis direction by as shown in FIG. 6(d). This is due to the fact that the sensing axis of rotational sensor 502 is now oriented between the y-axis and the z-axis (because of the orientation of the device in the user's hand). Similarly, the sensing axis of the rotational sensor 504 is also oriented between the y-axis and the z-axis (although in a different quadrant). In order to provide an interface which is transparent to the user in terms of how the 3D pointing device 400 is held, tilt compensation according to exemplary embodiments of the present invention translates the readings output from rotational sensors 502 and 504 back into the inertial frame of reference as part of processing the readings from these sensors into information indicative of rotational motion of the 3D pointing device 400.

According to exemplary embodiments of the present invention, returning to FIG. 5, this can be accomplished by determining the tilt of the 3D pointing device 400 using the inputs y and z received from accelerometer 506 at function 622. More specifically, after the acceleration data is converted and calibrated as described above, it can be low pass filtered at LPF 624 to provide an average acceleration (gravity) value to the tilt determination function 622. Then, tilt θ can be calculated in function 622 as:

$$θ = {tan}^{- 1} ( \frac{y}{z} ) \qquad ( 7 )$$

The value θ can be numerically computed as a tan 2(y,z) to prevent division by zero and give the correct sign. Then, function 620 can perform the rotation R of the converted/calibrated inputs αy and αz using the equation:

$$R = [ \begin{matrix}cos θ sin θ \\ - sin θ cos θ\end{matrix} ] \cdot [ \begin{matrix}α y \\ α z\end{matrix} ] \qquad ( 8 )$$

to rotate the converted/calibrated inputs αy and αz to compensate for the tilt θ.

Once the calibrated sensor readings have been compensated for linear acceleration, processed into readings indicative of angular rotation of the 3D pointing device 400, and compensated for tilt, post-processing can be performed at blocks 626 and 628. Exemplary post-processing can include compensation for various factors such as human tremor. Although tremor may be removed using several different methods, one way to remove tremor is by using hysteresis. The angular velocity produced by rotation function 620 is integrated to produce an angular position. Hysteresis of a calibrated magnitude is then applied to the angular position. The derivative is taken of the output of the hysteresis block to again yield an angular velocity. The resulting output is then scaled at function 628 (e.g., based on the sampling period) and used to generate a result within the interface, e.g., movement of a cursor 410 on a display 408.

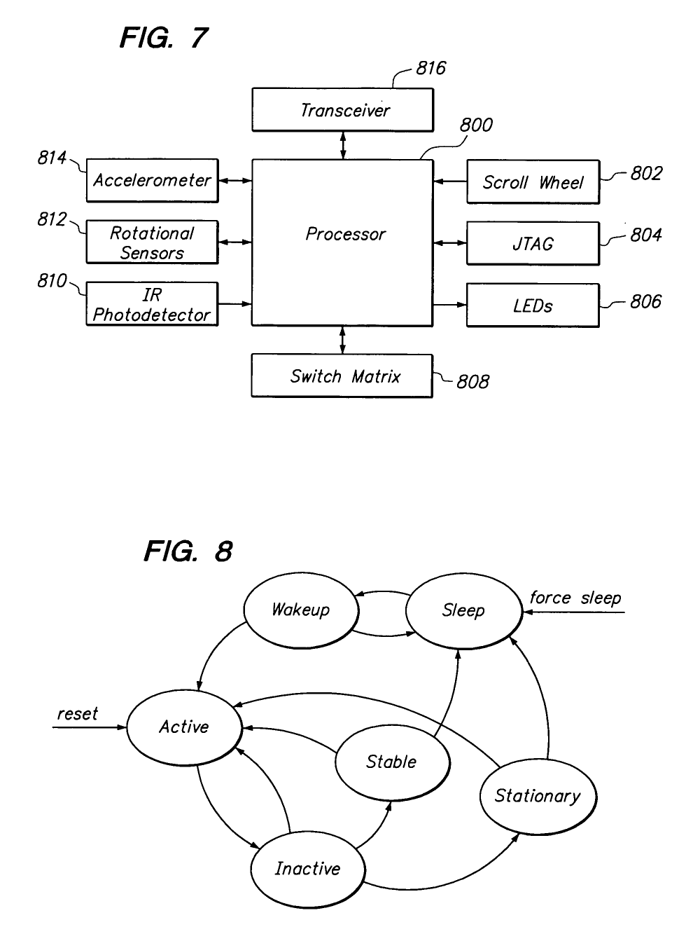

Having provided a process description of exemplary 3D pointing devices according to the present invention, FIG. 7 illustrates an exemplary hardware architecture. Therein, a processor 800 communicates with other elements of the 3D pointing device including a scroll wheel 802, JTAG 840, LEDs 806, switch matrix 808, IR photodetector 810, rotational sensors 812, accelerometer 814 and transceiver 816. The scroll wheel 802 is an optional input component which enables a user to provide input to the interface by rotating the scroll wheel 802 clockwise or counterclockwise. JTAG 804 provides the programming and debugging interface to the processor. LEDs 806 provide visual feedback to a user, for example, when a button is pressed. Switch matrix 808 receives inputs, e.g., indications that a button on the 3D pointing device 400 has been depressed or released, that are then passed on to processor 840. The optional IR photodetector 810 can be provided to enable the exemplary 3D pointing device to learn IR codes from other remote controls. Rotational sensors 812 provide readings to processor 840 regarding, e.g., the y-axis and z-axis rotation of the 3D pointing device as described above. Accelerometer 814 provides readings to processor 840 regarding the linear acceleration of the 3D pointing device 400 which can be used as described above, e.g., to perform tilt compensation and to compensate for errors which linear acceleration introduces into the rotational readings generated by rotational sensors 812. Transceiver 816 is used to communicate information to and from 3D pointing device 400, e.g., to the system controller 228 or to a processor associated with a computer. The transceiver 816 can be a wireless transceiver, e.g., operating in accordance with the Bluetooth standards for short-range wireless communication or an infrared transceiver. Alternatively, 3D pointing device 400 can communicate with systems via a wireline connection.

Stationary detection function 608, mentioned briefly above, can operate to determine whether the 3D pointing device 400 is, for example, either stationary or active (moving). This categorization can be performed in a number of different ways. One way, according to an exemplary embodiment of the present invention, is to compute the variance of the sampled input data of all inputs (x, y, z, αy, αz) over a predetermined window, e.g., every quarter of a second. This variance is then compared with a threshold to classify the 3D pointing device as either stationary or active.

Another stationary detection technique according to exemplary embodiments of the present invention involves transforming the inputs into the frequency domain by, e.g., performing a Fast Fourier Transform (FFT) on the input data. Then, the data can be analyzed using, e.g., peak detection methods, to determine if the 3D pointing device 400 is either stationary or active. Additionally, a third category can be distinguished, specifically the case where a user is holding the 3D pointing device 400 but is not moving it (also referred to herein as the “stable” state. This third category can be distinguished from stationary (not held) and active by detecting the small movement of the 3D pointing device 400 introduced by a user's hand tremor when the 3D pointing device 400 is being held by a user. Peak detection can also be used by stationary detection function 608 to make this determination. Peaks within the range of human tremor frequencies, e.g., nominally 8-12 Hz, will typically exceed the noise floor of the device (experienced when the device is stationary and not held) by approximately 20 dB

In the foregoing examples, the variances in the frequency domain were sensed within a particular frequency range, however the actual frequency range to be monitored and used to characterize the status of the 3D pointing device 400 may vary. For example, the nominal tremor frequency range may shift based on e.g., the ergonomics and weight of the 3D pointing device 400, e.g., from 8-12 Hz to 4-7 Hz.

According to another exemplary embodiment of the present invention, stationary detection mechanism 608 can include a state machine. An exemplary state machine is shown in FIG. 8. Therein, the ACTIVE state is, in this example, the default state during which the 3D pointing device 400 is moving and being used to, e.g., provide inputs to a user interface. The 3D pointing device 400 can enter the ACTIVE state on power-up of the device as indicated by the reset input. If the 3D pointing device 400 stops moving, it may then enter the INACTIVE state. The various state transitions illustrated in FIG. 8 can be triggered by any of a number of different criteria including, but not limited to, data output from one or both of the rotational sensors 502 and 504, data output from the accelerometer 506, time domain data, frequency domain data or any combination thereof. State transition conditions will be generically referred to herein using the convention “Condition_{stateA→stateB}”. For example, the 3D pointing device 400 will transition from the ACTIVE state to the INACTIVE state when condition_{active→inactive} occurs. For the sole purpose of illustration, consider that condition_{active→inactive} can, in an exemplary 3D pointing device 400, occur when mean and/or standard deviation values from both the rotational sensor(s) and the accelerometer fall below first predetermined threshold values for a first predetermined time period.

State transitions can be determined by a number of different conditions based upon the interpreted sensor outputs. Exemplary condition metrics include the variance of the interpreted signals over a time window, the threshold between a reference value and the interpreted signal over a time window, the threshold between a reference value and the filtered interpreted signal over a time window, and the threshold between a reference value and the interpreted signal from a start time can be used to determine state transitions. All, or any combination, of these condition metrics can be used to trigger state transitions. Alternatively, other metrics can also be used. According to one exemplary embodiment of the present invention, a transition from the INACTIVE state to the ACTIVE state occurs either when (1) a mean value of sensor output(s) over a time window is greater than predetermined threshold(s) or (2) a variance of values of sensor output(s) over a time window is greater than predetermined threshold(s) or (3) an instantaneous delta between sensor values is greater than a predetermined threshold.

The INACTIVE state enables the stationary detection mechanism 608 to distinguish between brief pauses during which the 3D pointing device 400 is still being used, e.g., on the order of a tenth of a second, and an actual transition to either a stable or stationary condition. This protects against the functions which are performed during the STABLE and STATIONARY states, described below, from inadvertently being performed when the 3D pointing device is being used. The 3D pointing device 400 will transition back to the ACTIVE state when conditionin_{active→active} occurs, e.g., if the 3D pointing device 400 starts moving again such that the measured outputs from the rotational sensor(s) and the accelerometer exceeds the first threshold before a second predetermined time period in the INACTIVE state elapses.

The 3D pointing device 400 will transition to either the STABLE state or the STATIONARY state after the second predetermined time period elapses. As mentioned earlier, the STABLE state reflects the characterization of the 3D pointing device 400 as being held by a person but being substantially unmoving, while the STATIONARY state reflects a characterization of the 3D pointing device as not being held by a person. Thus, an exemplary state machine according to the present invention can provide for a transition to the STABLE state after the second predetermined time period has elapsed if minimal movement associated with hand tremor is present or, otherwise, transition to the STATIONARY state.

The STABLE and STATIONARY states define times during which the 3D pointing device 400 can perform various functions. For example, since the STABLE state is intended to reflect times when the user is holding the 3D pointing device 400 but is not moving it, the device can record the movement of the 3D pointing device 400 when it is in the STABLE state e.g., by storing outputs from the rotational sensor(s) and/or the accelerometer while in this state. These stored measurements can be used to determine a tremor pattern associated with a particular user or users as described below. Likewise, when in the STATIONARY state, the 3D pointing device 400 can take readings from the rotational sensors and/or the accelerometer for use in compensating for offset as described above.

If the 3D pointing device 400 starts to move while in either the STABLE or STATIONARY state, this can trigger a return to the ACTIVE state. Otherwise, after measurements are taken, the device can transition to the SLEEP state. While in the sleep state, the device can enter a power down mode wherein power consumption of the 3D pointing device is reduced and, e.g., the sampling rate of the rotational sensors and/or the accelerometer is also reduced. The SLEEP state can also be entered via an external command so that the user or another device can command the 3D pointing device 400 to enter the SLEEP state.

Upon receipt of another command, or if the 3D pointing device 400 begins to move, the device can transition from the SLEEP state to the WAKEUP state. Like the INACTIVE state, the WAKEUP state provides an opportunity for the device to confirm that a transition to the ACTIVE state is justified, e.g., that the 3D pointing device 400 was not inadvertently jostled.

The conditions for state transitions may be symmetrical or may differ. Thus, the threshold associated with the condition_{active→inactive} may be the same as (or different from) the threshold(s) associated with the condition_{inactive→active}. This enables 3D pointing devices according to the present invention to more accurately capture user input. For example, exemplary embodiments which include a state machine implementation allow, among other things, for the threshold for transition into a stationary condition to be different than the threshold for the transition out of a stationary condition.

Entering or leaving a state can be used to trigger other device functions as well. For example, the user interface can be powered up based a transition from any state to the ACTIVE state. Conversely, the 3D pointing device and/or the user interface can be turned off (or enter a sleep mode) when the 3D pointing device transitions from ACTIVE or STABLE to STATIONARY or INACTIVE. Alternatively, the cursor 410 can be displayed or removed from the screen based on the transition from or to the stationary state of the 3D pointing device 400.

As mentioned above, the STABLE state can be used to memorize tremor data. Typically, each user will exhibit a different tremor pattern. This property of user tremor can also be used to identify users. For example, a user's tremor pattern can be memorized by the system (either stored in the 3D pointing device 400 or transmitted to the system) during an initialization procedure wherein the user is requested to hold the 3D pointing device as steadily as possible for, e.g., 10 seconds. This pattern can be used as the user's unique signature to perform a variety of user interface functions. For example, the user interface can identify the user from a group of user's by comparing a current tremor pattern with those stored in memory. The identification can then be used, for example, to retrieve preference settings associated with the identified user. For example, if the 3D pointing device is used in conjunction with the media systems described in the above-incorporated by reference patent application, then the media selection item display preferences associated with that user can be activated after the system recognizes the user via tremor pattern comparison. System security can also be implemented using tremor recognition, e.g., access to the system may be forbidden or restricted based on the user identification performed after a user picks up the 3D pointing device 400.

In the exemplary embodiment of FIG. 4, the 3D pointing device 400 includes two rotational sensors 502 and 504, as well as an accelerometer 506. However, according to another exemplary embodiment of the present invention, a 3D pointing device can alternatively include just one rotational sensor, e.g., for measuring angular velocity in the z-axis direction, and an accelerometer. For such an exemplary embodiment, similar functionality to that described above can be provided by using the accelerometer to determine the angular velocity along the axis which is not sensed by the rotational sensor. For example, rotational velocity around the y-axis can be computed using data generated by the accelerometer and calculating:

$${ω}_{Y} = \frac{\partial {θ}_{Y}}{\partial t} = \frac{\partial }{\partial t} {tan}^{- 1} ( \frac{x}{z} ) \qquad ( 9 )$$

In addition, the parasitic acceleration effects that are not measured by a rotational sensor should also be removed. These effects include actual linear acceleration, acceleration measured due to rotational velocity and rotational acceleration, and acceleration due to human tremor.
Gesture Input Classification

As mentioned above, handheld devices according to exemplary embodiments of the present invention can be used to provide and/or recognize gestures as inputs. These specific patterns of movement of the device can be recognized by the processing unit associated with the handheld device, by the system to which it communicates movement data or some combination thereof. Any number of predetermined patterns of movement can be stored in a memory device and compared with movements of the handheld device to identify whether a gesture has been performed by the handheld device (by the user). According to exemplary embodiments of the present invention, the classification process by which these gestures are recognized can be delineated so as to reduce the processing requirements associated with gesture identification and/or to coordinate a user's intention to perform a gesture with the handheld device and/or the system's recognition thereof.

According to some exemplary embodiments of the pre sent invention, a gestureo indication input can be provided by a user to indicate to a processing unit (either onboard the handheld device, at the system or some combination thereof) that a gesture is to be performed or is being performed. This enables the processing unit to more readily identify the gesture based on data output from one or more sensors associated with the movement of the handheld device, since the processing unit will know (at least roughly) when the gesture is being initiated. Moreover, it will coordinate the interface experience for the user who will expect movement subsequent to the gesture indication input to be interpreted as a gesture, e.g., one of those gestures identified in the above-incorporated by reference published patent application or some other pattern of movement which has been predetermined to correlate to a command or predetermined input. Yet another potential benefit of providing a gesture indication input is that processing resources used to perform the pattern recognition associate with gesture controls can be reduced since the processor(s) need not be continuously looking through movement data to identify gestures.

The gesture indication input can take many forms. According to one exemplary embodiment of the present invention, the gesture indication input can be a button press of a button disposed on the handheld device. However any other input can be designated as a gesture indication input, including a special gesture. For example, the processing unit can be programmed to recognize a special movement pattern, e.g., a punching movement away from the user or toward a display associated with the system, as the gesture indication input. In such exemplary embodiments, a user could first perform the special gesture, followed by another gesture, whereupon the processing unit would recognize that motion data received after the special gesture was intended to be evaluated for correlation to a gesture library, e.g., instead of as pointing data which is intended to move a cursor on a display screen.

Exemplary embodiments of the present invention can be implemented in many different ways. For example, according to one exemplary embodiment, a processing unit associated with the handheld device (either on-board or not), may only evaluate movement data received from one or more sensors associated with a handheld device for gesture identification if the gesture input indication is received. Alternatively, the gesture identification input can be used as an enhancement to the gesture classification scheme that is not required at all times. For example, different sets of gestures can be stored in a gesture library. The processing unit may continuously evaluate motion data received from the sensor(s) to determine if a gesture from a first set has been performed (without requiring receipt of the gesture indication input), but may only evaluate motion data received from the sensor(s) to determine if a gesture from the second set is performed upon receipt of the gesture indication input. This would enable, for example, the handheld device and/or system to segregate gestures that are easy to classify and/or commonly used from those which are more difficult to classify and/or less commonly used, the latter of which (or the former of which) could be looked for by the processing unit only upon receipt of the gesture indication input. The sets of gestures can be different from one another, but need not be mutually exclusive. More than two sets of gestures could be delineated.

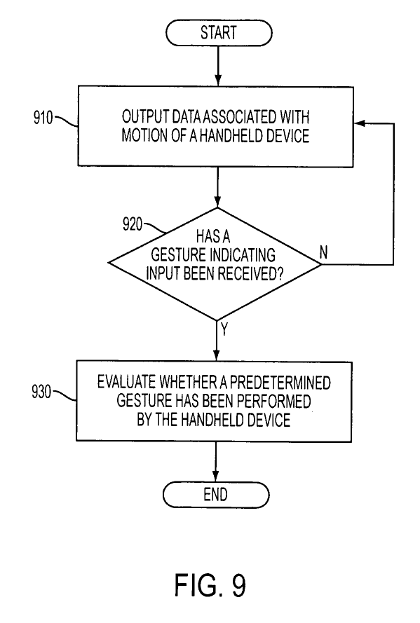

An exemplary method for processing gestures originating from a handheld device can be seen in the flowchart of FIG. 9. Initially, data associated with motion of a handheld device is output in step 910. In step 920, the processing unit determines whether a gesture indicating input has been received. If a gesture indicating input has been received, then in step 930, this data is evaluated by a processing unit to determine whether a predetermined gesture has been performed by the handheld device.

According to another exemplary embodiment of the present invention, gesture indication input can begin and end in a variety of methods. For example, the processing unit could be keyed to begin evaluation of a gesture by initially pressing and releasing a specific button. The processing unit then evaluates the gesture, until the signal for ending the gesture is received. In this exemplary embodiment, pressing and releasing another specific button would be the signal delineating the end of the gesture. The specific button pressed and released could be the same button for beginning and ending the evaluation time, or different buttons on the handheld device. Alternatively, the processing unit could end the process of gesture evaluation when no, or minimal, motion of the handheld is detected over a predetermined time period. In another alternate exemplary embodiment, the gesture evaluation process could be ended upon pressing any button or input control.

According to another exemplary embodiment of the present invention, an area on the display screen can be used to initiate the gesture evaluation process. If a user moves the cursor using the handheld device to a certain area (either visible or not visible) on the display screen and hovers in that area for a predetermined amount of time, the processor then starts to evaluate subsequent movement data as a potential gesture. The user would then perform the gesture and the processor would then be notified that the gesture was completed. As a purely illustrative example, consider an implementation wherein, if the cursor is moved roughly halfway down on the right hand side of the display and kept there for a short period of time, the processor will attempt to interpret subsequent handheld device motion data as a gesture (as long as the motion matches a pre-stored gesture). The gesture is performed by the user with the handheld device and the gesture evaluation process can then be ended by a plurality of methods, such as, pressing a button, pressing and releasing a specific button, no or minimal motion for a predetermined period of time, the cursor traveling greater than a predetermined relative distance, after one gesture is identified or when the pointer location is close to another designated portion of the display (corresponding to a section of the GUI) for a predetermined period of time.

According to other exemplary embodiments of the present invention, motion thresholds can be set such that when exceeded, the processing unit begins the gesture evaluation process. For example, acceleration thresholds, angular motion thresholds, distance thresholds or some combination thereof can be applied to the handheld device and evaluated on an ongoing basis to determine if a threshold has been crossed, which in turn alerts the processing unit to begin the gesture evaluation process. As described previously, a plurality of mechanisms exist for determining when the gesture evaluation period has been completed and could be used with these exemplary embodiments for beginning the gesture evaluation period. Additionally, these gestures can be linked to commands that are can be used in a repetitive manner. In a purely illustrative example, the command for increasing volume is linked to the gesture of crossing an acceleration threshold in a right to left direction. A user moves the handheld device in a right to left direction, crossing the required acceleration threshold and the volume increases by one volume increment. Alternatively, the magnitude of the acceleration could be related to the magnitude of the volume change. The user then moves the handheld device, again crossing the acceleration threshold, in a right to left direction and the volume increases again. Additionally, the opposite gesture could be linked to the command for reducing the relevant command. In this purely illustrative example, moving the handheld device from left to right and crossing the acceleration threshold would reduce the volume. One skilled in the art could link a variety of relatively opposite gestures to relatively opposite commands. Alternatively, similar gestures can be linked to similar commands. For example, the gesture of moving the handheld device a distance X in space fast forwards a movie 5 minutes, while moving the handheld device a distance of 2× in space fast forwards a movie 10 minutes.

According to another exemplary embodiment, speech can be used either in conjunction with previously discussed methods or alone to begin or end the gesture evaluation process.

According to yet another exemplary embodiment of the present invention, different gesture sets can exist for different GUI interface display levels in order to reduce processor requirements while still allowing for useful gestures to be recognized and processed. For example, consider a gesture that is related to increasing volume. This gesture could be omitted from a set of gestures that the processing unit looks for at a higher level of the interface where volume control is not relevant. However, upon reaching a level of the interface where there is something to be heard, the increasing volume gesture would then be added to the list of gestures to look for by the processing unit. These gestures can be initiated and ended in any of the exemplary methods previously described above.

Systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

The above-described exemplary embodiments are intended to be illustrative in all respects, rather than restrictive, of the present invention. Thus the present invention is capable of many variations in detailed implementation that can be derived from the description contained herein by a person skilled in the art. For example, although the foregoing exemplary embodiments describe, among other things, the use of inertial sensors to detect movement of a device, other types of sensors (e.g., ultrasound, magnetic or optical) can be used instead of, or in addition to, inertial sensors in conjunction with the afore-described signal processing. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A handheld device comprising:
at least one sensor for outputting data associated with motion of said handheld device;
a processing unit for evaluating said data to determine whether a predetermined gesture has been performed by said handheld device,
wherein said processing unit performs said evaluation in response to a receipt of a gesture indication input.

2. The handheld device of claim 1, wherein said handheld device includes at least one button and said gesture indication input is a button press.

3. The handheld device of claim 1, wherein said gesture indication input is a special gesture.

4. The handheld device of claim 3, wherein said special gesture is a punching motion away from a user of said handheld device.

5. The handheld device of claim 1, wherein said processing unit performs said evaluation only in response to said receipt of said gesture indication input.

6. The handheld device of claim 1, wherein said processing unit evaluates said data to determine whether a first set of gestures has been performed without receipt of said gesture indication input and evaluates said data to determine whether a second set of gestures has been performed only after receipt of said gesture indication input, said first set of gestures being different than said second set of gestures.

7. The handheld device of claim 1, wherein said gesture indication input begins with pressing and releasing a button, and said gesture indication input ends with pressing and releasing said button.

8. The handheld device of claim 1, wherein said gesture indication input begins with pressing and releasing a button, and said gesture indication input ends when minimal motion of said handheld device occurs over a predetermined period of time.

9. The handheld device of claim 1, wherein said gesture indication input occurs when a pointer location is proximate to a designated location on a graphical user interface for a predetermined period of time.

10. The handheld device of claim 9, wherein said gesture indication input ends with a button press.

11. The handheld device of claim 9, wherein said gesture indication input ends with a button press and release.

12. The handheld device of claim 9, wherein said gesture indication input ends when minimal motion of said handheld device occurs over a predetermined period of time.

13. The handheld device of claim 9, wherein said gesture indication input ends when a pointer location is proximate to a designated location on a graphical user interface for a predetermined period of time.

14. The handheld device of claim 1, wherein said gesture indication input occurs when motion of said handheld device exceeds a predetermined acceleration threshold

15. The handheld device of claim 1, wherein said gesture indication input occurs when motion of said handheld device exceeds a predetermined amount of angular motion.

16. The handheld device of claim 1, wherein different gesture sets exist for different graphical user interface display levels.

17. The handheld device of claim 1, wherein said predetermined gesture can also indicate a magnitude of an associated command.

18. The handheld device of claim 17, wherein an opposite of said predetermined gesture can be performed to indicate an opposite version of an associated command.

19. The handheld device of claim 1, wherein said gesture ends based upon relative cursor distance traveled.

20. The handheld device of claim 1, wherein said gesture indication input begins with a first speech command and said gesture indication input is terminated with a second speech command.

21. A method for processing gestures originating from a handheld device comprising:
outputting data associated with motion of said handheld device;
evaluating by a processing unit said data to determine whether a predetermined gesture has been performed by said handheld device,
wherein upon receipt of a gesture indication input, said processing unit performs said evaluating.

22. The method of claim 21, wherein said step of evaluating by a processing unit is performed by a processing unit associated with a system with which said handheld device communicates movement data.

23. The method of claim 21, wherein said step of evaluating by a processing unit is performed by a processing unit associated with said handheld device.

24. The method of claim 21, wherein said step of evaluating by a processing unit is performed by a combination of a first processing unit associated with said handheld device and a second processing unit associated with a system with which said handheld device communicates movement data.

25. The method of claim 21, wherein said handheld device includes at least one button and said gesture indication input is a button press.

26. The method of claim 21, wherein said gesture indication input is a special gesture.

27. The method of claim 26, wherein a punching motion away from a user of said handheld device is said special gesture.

28. The method of claim 21, wherein said processing unit performs said evaluation only in response to said receipt of said gesture indication input.

29. The method of claim 21, wherein evaluating said data to determine whether a first set of gestures has been performed without receipt of said gesture indication input and evaluates said data to determine whether a second set of gestures has been performed only after receipt of said gesture indication input, said first set of gestures being different than said second set of gestures, is performed by said processing unit.

30. The method of claim 21, wherein said gesture indication input begins with pressing and releasing a button, and said gesture indication input ends with pressing and releasing said button.

31. The method of claim 21, wherein said gesture indication input begins with pressing and releasing a button, and said gesture indication input ends when minimal motion of said handheld device occurs over a predetermined period of time.

32. The method of claim 21, wherein said gesture indication input occurs when a pointer location is proximate to a designated location on a graphical user interface for a predetermined period of time.

33. The method of claim 32, wherein ending said gesture indication input occurs with a button press.

34. The method of claim 32, wherein ending said gesture indication input occurs with a button press and release.

35. The method of claim 32, wherein ending said gesture indication input occurs when minimal motion of said handheld device occurs over a predetermined period of time.

36. The method of claim 32, wherein ending said gesture indication input ends when a pointer location is proximate to a designated location on a graphical user interface for a predetermined period of time.

37. The method of claim 21, wherein said gesture indication input occurs when motion of said handheld device exceeds a predetermined acceleration threshold.

38. The method of claim 21, wherein said gesture indication input occurs when motion of said handheld device exceeds a predetermined amount of angular motion.

39. The method of claim 21, wherein, different gesture sets exist for different graphical user interface display levels.

40. The method of claim 21, wherein said predetermined gesture can also indicate a magnitude of an associated command.

41. The method of claim 40, wherein an opposite of said predetermined gesture can be performed to indicate an opposite version of an associated command.

42. The method of claim 21, wherein said gesture ends based upon relative cursor distance traveled.

43. The method of claim 21, wherein said gesture indication input begins with a first speech command and said gesture indication input is terminated with a second speech command.

44. A means for processing gestures originating from a handheld device comprising:
means for outputting data associated with motion of said handheld device;
means for evaluating by a processing unit said data to determine whether a predetermined gesture has been performed by said handheld device,
wherein upon receipt of a gesture indication input, said processing unit performs said evaluating.

45. A computer-readable medium containing instructions which, when executed on a computer, perform the steps of:
outputting data associated with motion of said handheld device;
evaluating by a processing unit said data to determine whether a predetermined gesture has been performed by said handheld device,
wherein upon receipt of a gesture indication input, said processing unit performs said evaluating.
